(19) United States
(12) Patent Application Publication
(10) Pub. No.: US 2019/0239585 A1
(43) Pub. Date: Aug. 8, 2019

(54) MULTILAYERED THIN CHEMICAL RESISTANT ARTICLE AND MANUFACTURING METHOD

(71) Applicant: SHEN WEI (USA) INC., Union City, CA (US)

(72) Inventors: Belle L. Chou, Union City, CA (US); Sisitha Sudarshana, Athurugiriya (LK); Amila Suranga, Athurugiriya (LK)

(21) Appl. No.: 15/892,273

(22) Filed: Feb. 8, 2018

(51) Int. Cl. A41D 19/00; C09D 133/20; C09D 127/04; C09D 133/26; C09D 179/02; C09D 5/00; B32B 25/08; B32B 25/16; B29C 41/22; B29C 41/08

(52) U.S. Cl. CPC A41D 19/0058; C09D 133/20; C09D 127/04; C09D 133/26; C09D 179/02; C09D 5/002; B29K 2009/00; B32B 25/16; B29C 41/22; B29C 41/08; A41D 19/0006; B32B 2250/02; B32B 25/08

(57) ABSTRACT

A single use invertible elastomeric article with at least two polymeric layers. Each polymer in the two polymeric layers is a single, pure polymer and are different from each other, such that the single polymer of the first layer is not the same as the single polymer of the second layer. The first layer can comprise acrylonitrile butadiene and the second layer can comprise polychloroprene in an embodiment. The first layer is directly bonded to the second layer with a primer coating between the layers comprising a cationic polymer. There is a method of manufacturing the invertible elastomeric article comprising the steps of coating a former with a coagulant; applying a first polymeric coating of a single polymer; coating the first polymeric coating with a primer; and applying a second polymeric coating; the second polymeric coating comprises a single polymer different from the single polymer of the first polymeric coating.

### BACKGROUND OF THE INVENTION

### 1. Field of the Invention

The exemplary embodiment(s) of the present invention generally relates to thin, chemical resistant multilayered glove with optimized physical and chemical protection and the process of manufacturing the same.

### 2. Background

A principal problem with gloves used in working environments where harsh chemicals are frequently used is that they tend to be thicker, bulkier, and cause hand fatigue due to lack of glove suppleness. This is due to the enhanced protection from an extended cross-sectional thickness of the glove. A low thickness glove film provides lesser protection compared to high thickness glove film when other variables remain constant. This enhanced protection adds to the thickness of the glove while also increasing the cost of the glove and the complexity of the manufacturing process. A higher cross-sectional thickness provides more protection; however, the gloves do not provide adequate dexterity for smooth, sensitive work operations.

Each polymer type possesses a unique range of protection over chemicals based on its inherent chemical structural properties. Polymer blends are used in chemical resistant gloves rather than single polymer in order to improve its chemical resistance range. However, polymer blending is not a perfect method because most polymer materials have different chemical characteristics. Differences in chemical characteristics result in poor intermolecular bonding resulting in deteriorated physical properties and chemical barrier properties. Different polymer layering is a successful method in enhancing broader range chemical resistance without compromising desired properties.

Existing layered gloves may comprise two or more layers. These layers are different to each other by their polymer composition. Each layer can be blended or be a single polymer as per their construction. The following construction are possible with a layered glove: two different single polymer layers bonded together using a blended layer in between, a single polymer layer and a blended layer, and two blended layers. It is known that the performance of a layered glove produced using polymer blends to achieve compatibility between different polymeric layers is inferior to a combination of single polymeric layers of pure materials. For example, the performance of a nitrile glove of a given thickness compared to a nitrile and natural latex blended layer glove with a similar thickness is not comparable as the optimum protection is compromised in blended layered gloves.

Several single use gloves developed under the chemical resistant category provide splash resistance for selected groups of chemicals and are resistant to most of the general use solvents and solutions. Protection is limited to simple splash resistance. These gloves have two different polymer layers bonded to each other at the interface by having a blend of the two polymers on either side in order to provide compatibility for two polymers. The blend of the two polymers is used as an intermediate bonding layer. This intermediate bonding layer comprises approximately 40-60% of one polymer and 60-40% of the second polymer.

A disadvantage of the intermediate blended layer is the increased thickness of the glove without added protection. Material, time, energy and processing are increased, thus increasing the cost. Further, different polymers are not attached to each other through strong bonds because they are incompatibility with each other. It is common to use an intermediate layer to improve the compatibility of each type of polymer layer. Usually, this intermediate layer is a blend of those two polymers which attach from either side. However, this intermediate layer does not provide much contribution to the chemical and physical properties even though it adds additional thickness and weight to the glove and increases the complexity of the glove manufacturing process. This intermediate layer also reduces the dexterity of the glove and causes more work fatigue to hands due to bulkiness of the glove. Therefore, a blended intermediate layer is not a good option to achieve the compatibility of different, layered polymers.

Most single use gloves are made from acrylonitrile butadiene, polychloroprene, natural rubber latex, poly vinyl chloride and thermoplastic polyurethane or blends of two or more materials. These materials are chemically and structurally different from each other so they are not compatible. As an example, formation of a nitrile layer is a difficult task over a natural rubber layer. Even though a continuous layer is developed over another polymer, it is susceptible to splitting or delamination during general applications, especially when stretched or bent. Further donning and doffing treatments become complex due to the compatibility of different layers to those treatments.

Usually, polymer blends are not superior to the individual pure materials themselves. During the blending, some extreme and unique performance characteristics that are inherent to specific polymers are compromised by the added properties from the blended layer. However, the majority of layered chemical resistant gloves comprise a blended polymer layer instead of a pure polymer layer because the blended layer is to ensure proper bonding between two incompatible polymers. After making blended layers, both layers contain the same material in different concentrations, making them more compatible than having them individually. An example of a layered glove produced using polymer blends is two layers in which each layer comprise both acrylonitrile and polychloroprene latex. The first layer contains a higher acrylonitrile composition from 60-90%. An intermediate coagulant is used to coagulate the second blended layer over the first blended layer. However, in most circumstances, a blended polymer is inferior to the unblended material in terms of mechanical and chemical protection.

Layered polymer gloves contain different polymers with different characteristics and their chemical nature is different to each other. As such, washing and donning treatments can cause negative impact on the glove characteristics. Therefore, opportunities for cleaning gloves, (i.e. extended washing, chlorination) are limited or impossible. For certain polymers, chlorination is impossible to carry out as such treatment degrades the polymer. In such circumstances, polyurethane or other easy donning polymer coatings are applied in order to achieve an easy donning surface inside the glove. However, most of these coatings are susceptible to extended washing and cleaning procedures and would eventually be washed off/removed from the surface. These polymer coatings can also create some allergic reactions to certain users.

There exists a method of making a smooth surface for a polychloroprene glove, which improves donning of the glove. This process describes a long chain fatty acid derivative treatment over a primed polychloroprene layer. The polychloroprene layer was primed using diluted hydrochloric acid solution. The long chain carboxylic acid derivative coating and hydrogel coating facilitates donning enhancements of the glove. However, disadvantages of such a method are that further itching and allergy are expected issues on the direct contact of long chain fatty acid derivatives.

The curing process of blended layers is usually not smooth due to different activation energies of vulcanization. Therefore, a common accelerator system is not effective for the blend and accelerators such as dithiocarbonates and thiurams are added in excess to the compound in order to achieve expected cross link density. As such, improper curing and higher residual accelerator content are problems of using a common curing system for a polymer blend.

Accordingly, there is a need for a thin, elastomeric, single use, multilayered glove made of at least two single polymeric layers, each layer of a different polymer than the other, which has excellent broad spectrum chemical resistance that offers users dexterity, suppleness and reduces hand fatigue. There is also a need for easy donning and doffing of gloves that are multilayered made of single polymeric layers. There is a further need to have pure polymer layers, accelerators and activators at levels to avoid any excess residual accelerator content.

### SUMMARY

According to an embodiment of the present invention, there is an invertible elastomeric article comprising at least two layers, a first layer made of a single polymer and a second layer made of a single polymer. The single polymer of the first layer is a different polymer than the single polymer of the second layer, and the first layer is bonded to the second layer by a primer applied between the first layer and the second layer. The primer comprises a mixture of a cationic polymer and a cationic surfactant for improved bonding.

In further embodiments of the present invention, the different polymer is a polymer selected from a group consisting of acrylonitrile butadiene, polychloroprene, natural rubber latex, isoprene, butyl latex, fluorinated elastomers, poly vinyl acetate, and polyvinyl alcohol. In yet another embodiment, the first layer is a pure acrylonitrile butadiene layer and the second layer is a pure polychloroprene layer.

According to further embodiments, the primer comprises an acrylic based cationic polymer, for example a polyacrylamide or polyethyleneimine. In an exemplary embodiment, the cationic surfactant may comprise a quaternary ammonium surfactant.

In accordance with some embodiments of the present invention, there is a method of manufacturing an invertible elastomeric article, comprising the steps of: coating a heated former with a coagulant; applying a first polymeric coating of a single polymer; applying a primer over the first polymeric coating; and applying a second polymeric coating over the primed first polymeric coating, wherein the second polymeric coating is of a single polymer different from the single polymer of the first polymeric coating.

These features, advantages and other embodiments of the present invention are further made apparent, in the remainder of the present document, to those of ordinary skill in the art.

### BRIEF DESCRIPTION OF THE DRAWINGS

In order to more fully describe embodiments of the present invention, reference is made to the accompanying drawings. These drawings are not to be considered limitations in the scope of the invention, but are merely illustrative.

FIG. 1 illustrates a multilayered glove comprising at least two polymer layers, according to an embodiment of the present invention.

FIG. 2 illustrates a cross sectional view of a multilayered glove along Section 2-2 of FIG. 1, according to an embodiment of the present invention

FIG. 3 illustrates a method of making multilayered article, according to an embodiment of the present invention.

FIG. 4 illustrates puncture resistance after ten minutes of exposure to a challenge chemical, according to an embodiment of the present invention.

### DETAILED DESCRIPTION OF SPECIFIC EMBODIMENTS

The description above and below and the drawings of the present document focus on one or more currently preferred embodiments of the present invention and also describe some exemplary optional features and/or alternative embodiments of the present invention. The description and drawings are for the purpose of illustration and not limitation. Those of ordinary skill in the art would recognize variations, modifications, and alternatives. Such variations, modifications, and alternatives are also within the scope of the present invention. Section titles are terse and are for convenience only.

Throughout the description and drawings, example embodiments of the present invention are given with reference to specific configurations. It will be appreciated by those of ordinary skill in the art that the present invention can be embodied in other specific forms. Those of ordinary skill in the art would be able to practice such other embodiments of the present invention without undue experimentation. The scope of the present invention, for the purpose of the present patent document, is not limited merely to the specific example embodiments of the present invention or alternatives of the foregoing description.

Various embodiments of the present invention illustrated in the drawings may not be drawn to scale. Rather, the dimensions of the various features may be expanded or reduced for clarity. In addition, some of the drawings may be simplified for clarity. Thus, the drawings may not depict all of the components of a given apparatus (e.g., device) or method. Unless the meaning is clearly to the contrary, all ranges set forth herein are deemed to be inclusive of the endpoints. The primer disclosed herein can also be referred to as a primer solution or a primer coating. The coagulant can be referred to as a coagulant coating.

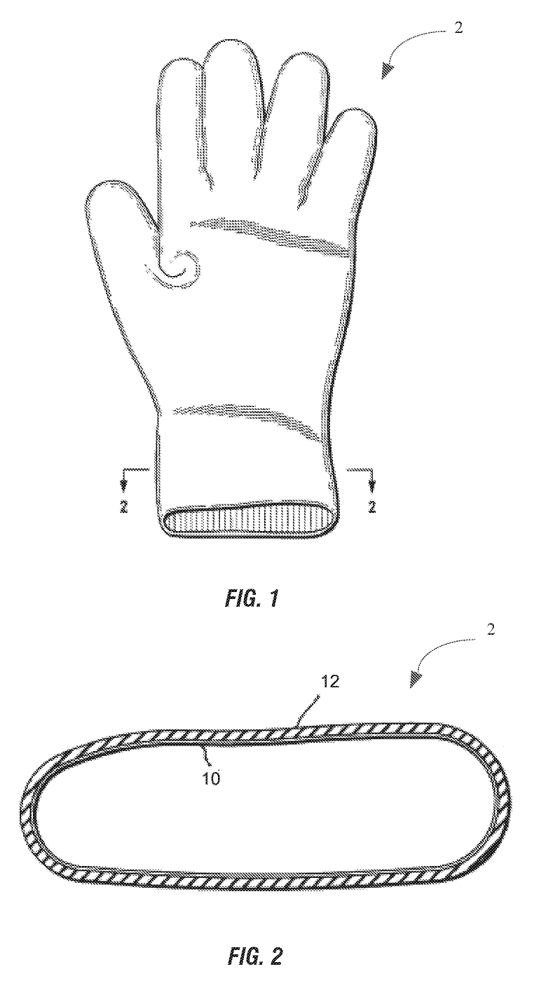

As illustrated in FIG. 1, there is a multilayered article, such as a single use, fluid impermeable, elastomeric glove 2 comprising at least two layers bonded to each other using a primer comprising a mixture of a cationic polymer and a cationic surfactant for improved bonding between both polymer layers. The cationic polymer can comprise a polyacrylamide or polyethyleneimine, or any combination thereof. The first layer 10 and the second layer 12 of the glove 2 can be used for different applications. The glove 2 offers resistance to mineral acids, bases and solvents as a result of the multilayered structure in combination with mechanical resistance. In addition to being a glove 2, the material can be made into articles such as mittens, aprons, or any type of skin protecting device made from layered polymers.

FIG. 2 illustrates a cross sectional view of a multilayered glove 2 along Section 2-2 of FIG. 1, according to an embodiment. The multilayered glove 2 comprises at least two layers. As illustrated in FIG. 2, the glove 2 comprises a first layer 10 of a single polymer and a second layer 12 of a single polymer. The single polymer of the first layer 10 is a different polymer than the single polymer of the second layer 12. The first layer 10 and second layer 12 are directly bonded together by a primer coating between the layers. The primer coating is not an intermediate blended polymer layer, nor does it add to the total thickness or weight of the glove 2. Immediately after manufacturing of the glove 2, i.e. after the glove 2 is stripped from a former, the second layer 12 is the inside, skin-facing side. However, as discussed below, the glove 2 is invertible/reversible, in that inverting the glove 2 is possible such that the first layer 10 can become the inside skin facing side.

The first layer 10 may comprise acrylonitrile butadiene, which protects against oil/non-polar solvents and mechanical hazards. When the user is working with non-polar solvents or when there is a risk of mechanical hazards, the first layer 10 comprising the acrylonitrile butadiene will be the outer-facing layer. The first layer 10 is made of about 100% acrylonitrile butadiene and the second layer 12 is made of about 100% polychloroprene with a primer coating in between the first layer 10 and the second layer 12. Usually polychloroprene is resistant to mineral acids while acrylonitrile butadiene's resistance to mineral acids is poor. Acrylonitrile butadiene rapidly degrades when exposed to about 96% sulphuric acid, losing its mechanical properties. However, the mineral acid does not permeate to the hand due to the resistance of polychloroprene. In such situations, the user can invert the glove 2 and expose the second layer 12 comprising polychloroprene to the chemical, thus use the glove 2 without compromising mechanical properties. The glove 2 is therefore invertible, i.e. can be reversibly worn. As such, inverting the glove 2 when worn by the user is another possibility including changes in the thickness ratios of the first layer 10 to the second layer 12.

The first layer 10 of acrylonitrile butadiene imparts good mechanical resistance such as resistance to abrasion and resistance to puncture which is an inherent feature of acrylonitrile butadiene. The first layer 10 of the glove 2 is modified to facilitate superior film formation and bonding for polychloroprene.

The second layer 12 comprises polychloroprene, which is resistant to mineral acids and bases. When handling acids or bases or when exposed to an acid-base related chemical risk, the wearer can invert the glove 2 to have the second layer 12 comprising polychloroprene be the outer-facing layer. Therefore, the glove 2 provides a hybrid glove which can be worn on either side enhancing its versatility for use in different applications that pose different chemical and mechanical risks and it offers effective resistance against a broad chemical spectrum. As for the second layer 12, it comprises about 100% polychloroprene polymer material which accounts for about 50-70% of the glove's 2 thickness and weight. This polychloroprene polymer layer provides an outstanding resistance to mineral acids, bases, and phosphate esters. The polychloroprene polymer layer comprises specially formulated ingredients which are allergy-free by using curing ingredients which do not cause any allergy reactions to sensitive users.

In an embodiment of the glove 2, the first layer 10 comprises about 100% acrylonitrile butadiene, which covers 30-50% of the thickness of the glove 2. The second layer 12 comprises about 100% polychloroprene, which accounts for 50% of the rest in terms of thickness. In another embodiment, the first layer 10 can be 40%-60% of the thickness of the glove 2 and the second layer 12 can be 60%-40% of the total thickness of the glove 2.

The two polymers can be selected from a list of alternative polymers for constructing a similar multilayered glove using the disclosed process, including: natural rubber latex, acrylonitrile butadiene, isoprene, polychloroprene, butyl latex, fluorinated elastomers, poly vinyl acetate, and polyvinyl alcohol. Polymer type can be selected based on the application and those polymers can be interchanged. Typically, acrylonitrile is used for the first layer 10 for good mechanical properties and oil resistance. If mechanical properties are a second priority, the acrylonitrile can be used in the second layer 12. The total thickness of the glove 2 can be about 0.10 millimeters-0.30 millimeters.

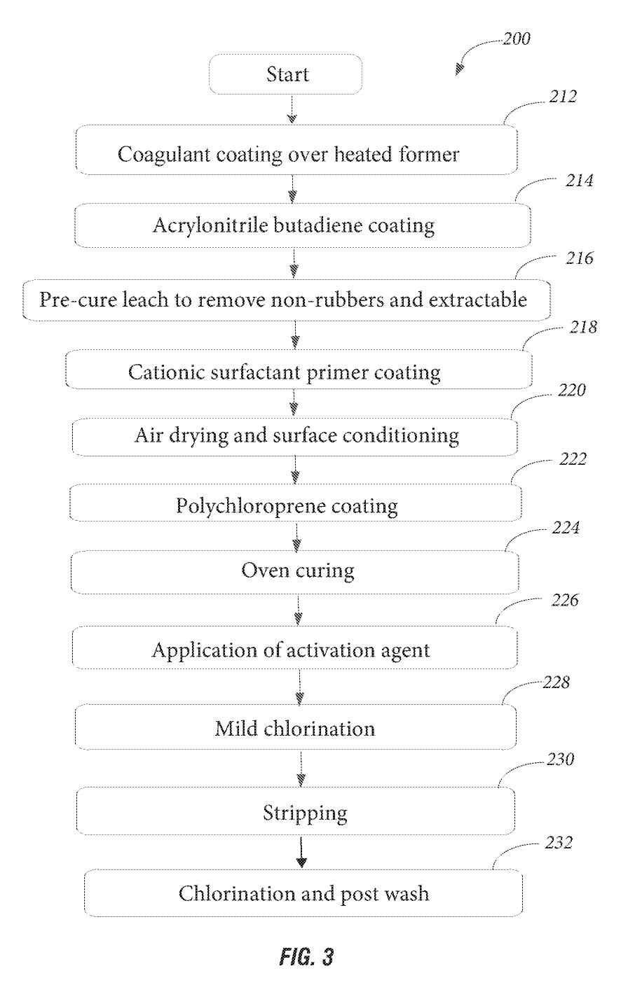

Specially formulated acrylonitrile butadiene is used for this product in order to ensure chemical resistance against hydrocarbons, alcohols and oils. Typically, the first layer 10 accounts for more than 60% of a total glove's thickness and weight. However, in this embodiment of the present invention, the first layer 10 is accountable for approximately 30-50% of the total glove 2 thickness and weight. The purpose of lowering the thickness contribution of the first layer 10 is to allow sufficient coverage of the second layer 12 compared to conventional multilayered gloves. The solid contents of the first layer 10 are maintained at a minimum possible level while controlling the gelling strength of the compound mixture. In addition, the strength of the coagulant, into which a former is dipped before the first layer 10 is applied, is maintained to a moderate high level with minimized dwelled time. The temperature of the former is maintained at about 55-58° C. before the coagulant dipping step 212 (See FIG. 3).

The second layer 12 comprises about 100% polychloroprene polymer and is treated with an activator in order to provide a suitable surface for chlorination. Treatment with an activation agent comprises treating the gelled polychloroprene polymer layer with an acidified solution of about 10% potassium chloride for about 2-5 seconds. This treatment can be applied either before air drying and surface conditioning (step 220) or alternatively after oven curing (step 224). Polychloroprene polymer offers extended protection against acids, bases and aviation fluid resistance. In another embodiment, an off-line chlorination cycle is used to chlorinate the first layer 10 of the glove 2. Off-line is when the glove 2 is off the former. The off-line chlorination is to provide chlorination to the outside facing layer of the glove 2. This improves chemical resistance of the glove 2. Extraordinary cleanliness is an added advantage to this treatment. An online chlorination tank is used with elevated chlorine strength for polychloroprene polymer. The exposing time is about 15-25 seconds and the strength of the solution is about 200-300 ppm. The primary purpose of this treatment is to improve donning over the skin-facing surface.

FIG. 3 illustrates a method 200 of making the multilayered article, for example a glove 2, according to an embodiment of the present invention. Coagulant strength, the solid contents of the first layer 10, viscosity, level of activators and degree of maturation are factors that maintain the glove 2 profile. In addition, production process specifications including temperature, dipping line arrangements, drying durations, leaching time and temperature are requirements to maintain the glove 2 profile. All these parameters are monitored to ensure proper glove layer formation for an optimized glove profile.

A coagulant coating is applied to a heated former at step 212. The coagulant coating is a water based calcium nitrate of calcium chloride solution. Based on the production line requirement, methanol or isopropanol can be added to the coagulant coating. The purpose of this addition is to accelerate dryness and increase cleanliness. In addition, wetting agents and anti-webbing materials can be incorporated into the coagulant coating. According to an embodiment, heated formers at step 212 are dipped in a bath of the coagulant coating and withdrawn after 3-5 seconds. The withdrawn formers are kept on a continuous rotating upright position.

An acrylonitrile butadiene coating is then applied over the coagulant coating at step 214. The acrylonitrile butadiene coating mixture is prepared by adding curing agents, accelerators and activators to the base polymer. Further stabilizers, pigments and viscosity modifiers are added to the mixture. This mixture is kept at maturation for about 16-48 hours at room temperature. The matured mixture is coated on the coagulant coated former after proper drying. According to an embodiment, the acrylonitrile butadiene coating is applied onto the coagulant coated former at about 40-60° C. using a dipping method.

The gloves 2 undergo a pre-cure leach to remove non-rubbers and extractable at step 216. Online warm water leaching and air drying while the gloves 2 are on the former is used in the process for removing water-soluble impurities and excess coagulant from the surface prior to the primer coating. This is done at about 40-65° C. water for about 40-240 seconds.

The leached acrylonitrile butadiene layered gloves 2 are dip coated into a cationic surfactant primer coating at step 218. The primer coating facilitates bonding of the first layer 10 (acrylonitrile butadiene) to a second layer 12 (e.g. polychloroprene) using a primer treatment method according to an embodiment of the present invention. The primer coating provides a suitable binding interface for both the acrylonitrile butadiene (first layer 10) and polychloroprene (second layer 12) layers.

According to an embodiment, the primer is applied over a partially dried acrylonitrile butadiene surface using a dipping method at step 218. In particular, the former after step 216 is dipped into a primer solution for creating a primer coating. The primer solution comprises a mixture of a cationic polymer, cationic surfactant, anionic surfactant, acrylic surfactant, and non-ionic surfactant to improve film forming and bonding characteristics over the primary acrylonitrile butadiene layer. In an exemplary embodiment, the cationic polymer is acrylic based and can be polyacrylamide or polyethyleneimine. The cationic surfactant is a quaternary ammonium compound and can be stearalkonium chloride or alkyltrimethylammonium bromide. The anionic surfactant is sodium dodecylbenzene and contains at least one branched dodecyl benzene sulfonic acid and linear dodecyl benzene sulfonic acid at about 2-2.5% solid content. There is about 1-1.5% of non-ionic surfactant to assist in the even wetting characteristics and thin uniform layer formation. The non-ionic surfactant provides better wetting properties for the ingredients in the primer solution. The anionic surfactant and the cationic surfactant provide better spreading on top of the polymer.

The acrylic based cationic polymer and anionic surfactant(s) are mixed with each other at 1:1 ratio by weight. Water is added to the mixture under continuous mixing. The mixed solution is strained to remove any undissolved materials. The filtered solution is then mixed with cationic and non-ionic surfactant. The total solid content of this primer mixture does not exceed about 10% by its total solid content. The primer dipping tank can be maintained at room temperature as applicable.

This primer solution facilitates the compatible bonding between the first layer 10 and second layer 12. Without the primer solution, since the layers are of two different single polymers, the bonding between these two layers would not be adequately strong and there would be a higher tendency to delaminate at the exposure to solvents or in stretching under stress. The primer coating between the first layer 10 and second layer 12 according to the present invention therefore facilitates the bonding between the second layer 12 and the first layer 10. The components in the primer have emulsification characteristics. Molecules of the primer create a temporary uniform penetration over the most outer surface molecules of the partially gelled first layer 10 polymer on the dried coagulant coating. The primer solution then penetrates into the micro level openings of the first layer 10 and develops a proper binding between the first layer 10 and the second layer 12. The other cationic substances of the primer provide additional support for the polymer of the second layer 12, i.e. polychloroprene coating, to gel, by initially depositing a thin uniform micro-level layer of the polychloroprene material, which serves as a foundation for the rest of the polychloroprene film build up.

The primer solution coated gloves undergo air drying at step 220 for about 2-5 minutes and continuous rotation is preferred to accelerate drying. Surface conditioning is taken place by the activity of the priming mixture. The primer solution is air dried to remove excess water from the surface which facilitates more affinity to the subsequently applied second layer 12, e.g. polychloroprene coating. The polychloroprene coating is applied at step 222 to form the second layer 12. The second layer 12 is coated on top of the dried first layer 10 which has been primed using the primer coating. The polychloroprene coating is applied as a solution prepared by adding curing agents, accelerators and activators to a base polychloroprene material. In addition, surfactants, colour pigments, viscosity, and modifiers are added to the solution. The total solid content is maintained at a higher level, about 30-40%, in order to deposit a thicker layer on top of acrylonitrile butadiene coating (i.e. first layer 10). The temperature is maintained at about 25-35° C.

The gloves are oven cured at step 224. The temperature of the oven during the first 25%-40% of the curing process is maintained with a higher air flow rate at about 100-110° C. During the rest of the curing process, there is low air flow and the oven temperature is about 130-145° C. As an optional step, the polychloroprene coating is leached before the oven curing step 224, which improves donning.

The gloves undergo application of an activation agent at step 226 and a mild chlorination at step 228 follows. The surface activation treatment using the activation agent removes residuals and some water-soluble materials such as surfactants. The purpose of an activation agent is to achieve/facilitate subsequent surface treatment for better donning on the polychloroprene layer. The activation agent comprises a catalyst for a chlorination reaction and it will help to increase the degree of chlorination by activation of the unsaturations in the polymer. The activation agent is a mixture of hydrogen fluoride and dichloroisocyanuric acid having about 5%-7% total solid. At least addition of one chlorine atom is expected over the double bond. Usually chlorination in a water medium facilitates the addition of Cl⁻ and OH⁻ across the double bond. The activation agent increases the efficiency of the chlorination reaction by about 20-30% higher than the usual chlorination. This helps lower the strength of the chlorination solution that is used for chlorination or to reduce the time of exposure to the chlorination reaction. Even though chlorination of polychloroprene is not a common practice in single use gloves due to its poor efficiency, this new process of chlorination using an activation agent helps achieve a sufficient chlorination of the polymer providing good donning of the polychloroprene second layer 12.

The mild chlorination at step 228 comprises treatment with 200-300 ppm chlorinated water solution for removing excess soluble materials and to provide a smoother inner surface for donning. Chlorine gas is dissolved in water as per the required concentration. The ceramic former (containing the polymeric glove 2) is exposed to the chlorine solution using a dipping method.

The gloves are stripped off the former at step 230 and undergoes a chlorination and post wash at step 232. The post wash is done in a neutralization solution followed by rinsing and post cure leaching treatments to remove any chemical residuals.

According to an embodiment of the present invention, the multilayered glove 2 comprises a first layer 10 of pure polymer and a second layer 12 of pure polymer that is different from the pure polymer of the first layer 10. The glove 2 comprises a first layer 10 of 100% acrylonitrile butadiene without compromising its optimum oil and non-polar chemical resistance, which is at the highest rating among common polymers, to achieve compatibility. If a blended layer is in place of the pure polymer layer, the above chemical resistance gets compromised due to the polymer chain incompatibilities. It would lead to increased thickness of such blended layers in order to obtain similar chemical resistance to that of the pure polymer; thus, compromising the dexterity and suppleness which is desired for long working hours in harsh environments. An acrylonitrile butadiene layer provides a higher resistance to abrasion and puncture risks compared to other blended layers. The second layer 12 comprising about 100% polychloroprene accounts for good resistance to mineral acids and bases which is better than any blended polymer layer of polychloroprene.

The glove 2 comprises two unblended layers which have separate optimized formulations with different activator and accelerator levels. The curing systems are simple and they only contain non-allergenic accelerators at lower dosages that are required to ensure the optimum degree of curing. Therefore, generation of unwanted impurities and toxic residuals are minimized in the present invention to eliminate the possibility of any allergy reactions to the users.

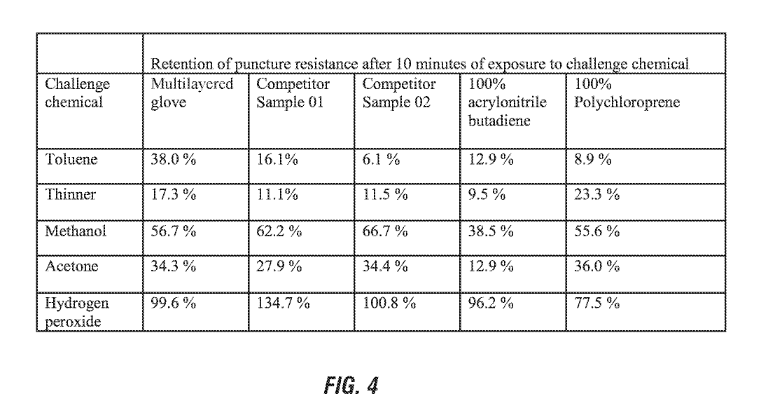

FIG. 4 illustrates puncture resistance after ten minutes of exposure to a challenge chemical, which is to identify resistance to degradation. Usually, chemical resistant gloves provide acceptable resistance to the chemicals as per the application. In this evaluation, both acrylonitrile butadiene only and polychloroprene only glove samples were used for comparison of properties against the dual polymer construction of the multilayered glove 2 of the present invention. These samples were 100% pure and unblended and the thickness similar to the multilayered glove 2. Six circular test specimens were cut from the working area of each glove type. Puncture resistance of those three of the test specimens were measured according to EN 388 puncture resistance test. The other three test specimens were exposed to the chemicals for ten minutes. Puncture resistance of these samples were measured right after ten minutes and percentage retention was calculated.

The present invention can be expanded to any polymeric protective wear for enhanced chemical and mechanical protection including a chemical resistant apron, gown, protective shield etc. Incorporation of lining material including synthetic or natural fiber, cotton, polymeric either on the first layer 10 or second layer 12 is another possible alteration for the present invention. The fabric liner can be attached to the polymeric base glove either in a dipping or dressing method as applicable. The thickness of the glove 2 is variable and the ratio of the thickness of each polymer layer can also be modified. Further, the selection of polymers for the primer is a possible alternative within the scope of the present invention. Alternatively, the glove 2 can be made on a textured or patterned former to add a grip pattern.

In the present invention, interface binding was developed after a series of laboratory and online production plant trials. The development of surface treatments and surface priming has also been used in this present invention. Ratios, formulations and process parameters are unique. Many market available chemical resistant layered gloves contain at least one major blended layer comprising two or more polymers to overcome related common issues on layering. This invention and its production process are capable of overcoming those issues.

While particular embodiments of the present invention have been shown and described, it will be obvious to those of skills in the art that based upon the teachings herein, changes and modifications may be made without departing from this exemplary embodiment(s) of the present invention and its broader aspects. Therefore, the appended claims are intended to encompass within their scope all such changes and modifications as are within the true spirit and scope of this exemplary embodiment(s) of the present invention.

1. An invertible elastomeric article comprising:
a first layer made of a single polymer and a second layer made of a single polymer, the single polymer of the first layer being a different polymer than the single polymer of the second layer;
the first layer directly bonded to the second layer by a primer coating applied uniformly between the first layer and the second layer, the primer coating comprising a mixture of a cationic polymer and a cationic surfactant for improved direct bonding between the first layer and the second layer.

2. The elastomeric article of claim 1, wherein the cationic polymer is acrylic based.

3. The elastomeric article of claim 1, wherein the cationic polymer is selected from the group consisting of polyacrylamide, polyethyleneimine, and combinations thereof.

4. The elastomeric article of claim 1, wherein the cationic surfactant is a quaternary ammonium surfactant.

5. The elastomeric article of claim 1, wherein the different polymer is selected from the group consisting of acrylonitrile butadiene, polychloroprene, natural rubber latex, isoprene, butyl latex, fluorinated elastomers, poly vinyl acetate, and polyvinyl alcohol.

6. The elastomeric article of claim 1, wherein the first layer is about 40%-60% of a total thickness of the article.

7. The elastomeric article of claim 1, wherein the second layer is about 40%-60% of a total thickness of the article.

8. The elastomeric article of claim 1, wherein the different polymer is acrylonitrile butadiene which is about 30%-50% of a total thickness of the article.

9. The elastomeric article of claim 1, wherein the different polymer is polychloroprene which is about 50%-70% of a total thickness of the article.

10. The elastomeric article of claim 1, wherein a total thickness of the article is about 0.10 millimeters-0.30 millimeters.

11. An invertible elastomeric article comprising:
a first layer comprising acrylonitrile butadiene and a second layer comprising polychloroprene; and
a primer mixture directly bonding the first layer and the second layer uniformly together, the primer mixture comprising an cationic polymer and a cationic surfactant.

12. A method of manufacturing an invertible elastomeric article for protecting skin, comprising the steps of:
a) coating a heated former with a coagulant;
b) applying a first polymeric coating made of a single polymer;
c) applying a primer uniformly over the first polymeric coating, forming a primed first polymeric coating; and
d) applying a second polymeric coating to the primed first polymeric coating so that the primed first polymeric coating bonds directly to the second polymeric coating, wherein the second polymeric coating is made of a single polymer different from the single polymer of the first polymeric coating.

13. The method of manufacturing an elastomeric article of claim 12, wherein the first polymeric coating is acrylonitrile butadiene.

14. The method of manufacturing an elastomeric article of claim 12, wherein the primer is a mixture of a cationic polymer and a cationic surfactant.

15. The method of manufacturing an elastomeric article of claim 12, wherein the second polymeric coating is polychloroprene.

16. The method of manufacturing an elastomeric article of claim 12, further comprising the steps of:
e) air drying and surface conditioning;
f) oven curing;
g) applying an activation agent; and
h) applying chlorination.

17. The method of manufacturing an elastomeric article of claim 16, wherein the step of applying an activation agent occurs after step e) or after step f).

18. The method of manufacturing an elastomeric article of claim 12, further comprising a step of leaching after step d).

19. The method of manufacturing an elastomeric article of claim 16, further comprising the steps of:
i) stripping the elastomeric article off the former; and
j) chlorinating and post washing the article.

20. The method of claim 16, wherein the activation agent is a mixture of hydrogen fluoride and dichloroisocyanuric acid.
